(19) United States
(12) Patent Application Publication
(10) Pub. No.: US 2023/0224791 A1
(43) Pub. Date: Jul. 13, 2023

(54) MANAGEMENT COMMUNICATION IN NTN ENVIRONMENT

(71) Applicant: LG Electronics Inc., Seoul (KR)

(72) Inventors: Jinwoong Park, Seoul (KR); Yoonoh Yang, Seoul (KR); Jinyup Hwang, Seoul (KR); Sangwook Lee, Seoul (KR); Suhwan Lim, Seoul (KR); Jaehyuk Jang, Seoul (KR)

(21) Appl. No.: 17/963,676

(22) Filed: Oct. 11, 2022

(30) Foreign Application Priority Data
Jan. 7, 2022 (KR) 10-2022-0003003

(51) Int. Cl. H04W 36/32; H04W 36/00

(52) U.S. Cl. CPC H04W 36/32; H04W 36/0058; H04W 84/06

(57) ABSTRACT

A disclosure of this specification provides a method for radio communication, performed by a user equipment (UE). The method is comprising: transmitting a random access preamble to an NTN (Non-Terrestrial Network) cell; receiving a random access response from the NTN cell; searching for a TN (Terrestrial Network) cell with a period T, wherein the T is determined based on i) distance between location of the UE and reference location of the TN, ii) signal power from the TN cell and iii) service time of the NTN cell.

### CROSS-REFERENCE TO RELATED APPLICATIONS

Pursuant to 35 U.S.C. §119(a), this application claims the benefit of Korean Patent Application No. 10-2022-0003003 filed on Jan. 7, 2022, the contents of which are all hereby incorporated by reference herein in their entirety

### Technical Field

The present disclosure relates to mobile communication.

### Background

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

NTN communication has a very large cell radius compared to the existing mobile communication network. A large path loss may occur due to a large cell radius. Due to the large path loss, lower throughput and low service quality than terrestrial networks are expected. Therefore, if the existing terrestrial network technology is applied to NTN communication as it is, inefficiency may occur.

In NTN communication, a specialized search period setting and cell reselection setting are required.

### SUMMARY

The UE of the NTN cell sets the discovery period in consideration of the distance from the TN cell, and the like. Furthermore, the margin is adjusted to facilitate cell reselection to TN cells.

In accordance with an embodiment of the present disclosure, a disclosure of this specification provides a method for radio communication, by performed a user equipment (UE). The method is comprising: transmitting random access preamble to an NTN (Non-Terrestrial Network) cell; receiving random access response from the NTN cell; searching for a TN (Terrestrial Network) cell with a period T, wherein the T is determined based on i) distance from the TN cell, ii) signal power from the TN cell and iii) service time of the NTN cell.

The present disclosure can have various advantageous effects.

For example, by adjusting the measurement period, the battery consumption of the terminal can be reduced, cell search can be performed effectively, and efficient mobility support can be expected.

For example, by making it easier for a UE to be served in the TN cell, better communication quality can be provided to the user.

Advantageous effects obtained through specific examples of the present specification are not limited to the effects listed above. For example, there may be a variety of technical effects that a person having ordinary skill in the related art can understand or derive from this specification. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of a wireless device to which implementations of the present disclosure is applied.

FIG. 4 shows an example of UE to which implementations of the present disclosure is applied.

FIG. 5 is an example of a wireless communication system.

FIG. 6 illustrates a structure of a radio frame used in NR.

FIG. 7 shows an example of subframe type in NR.

FIG. 8 shows an example of performing measurement in E-UTRAN and NR (EN) DC case.

FIG. 9 shows an example of performing measurement in NR carrier aggregation case.

FIG. 10 shows Non-terrestrial network typical scenario based on transparent payload.

FIG. 11 shows Non-terrestrial network typical scenario based on regenerative payload.

FIG. 12 shows shows a state of a UE related to measurement according to an embodiment of the present specification.

FIG. 13 shows a procedure of UE according to the first disclosure of the present specification.

FIG. 14 shows a procedure of UE according to the second disclosure of the present specification.

### DETAILED DESCRIPTION OF THE EMBODIMENTS

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. Evolution of 3GPP LTE includes LTE-A (advanced), LTE-A Pro, and/or 5G NR (new radio).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

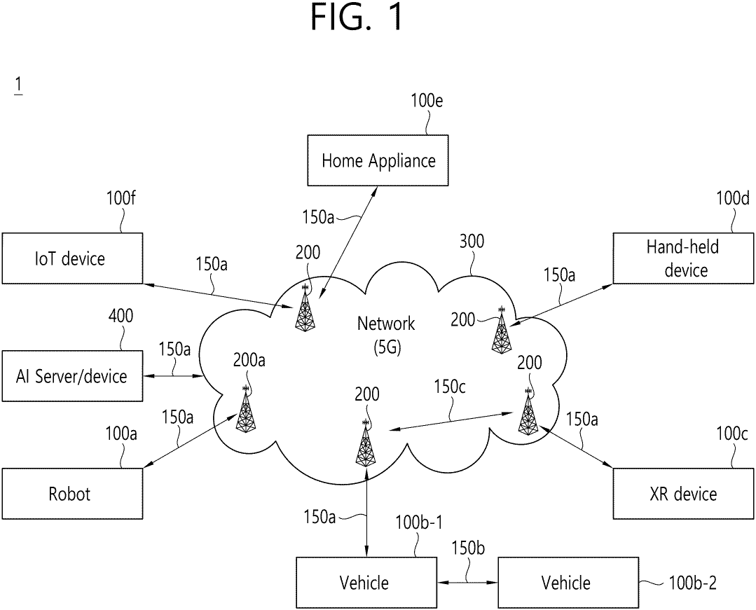

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

AI refers to the field of studying artificial intelligence or the methodology that can create it, and machine learning refers to the field of defining various problems addressed in the field of AI and the field of methodology to solve them. Machine learning is also defined as an algorithm that increases the performance of a task through steady experience on a task.

Robot means a machine that automatically processes or operates a given task by its own ability. In particular, robots with the ability to recognize the environment and make self-determination to perform actions can be called intelligent robots. Robots can be classified as industrial, medical, home, military, etc., depending on the purpose or area of use. The robot can perform a variety of physical operations, such as moving the robot joints with actuators or motors. The movable robot also includes wheels, brakes, propellers, etc., on the drive, allowing it to drive on the ground or fly in the air.

Autonomous driving means a technology that drives on its own, and autonomous vehicles mean vehicles that drive without user’s control or with minimal user’s control. For example, autonomous driving may include maintaining lanes in motion, automatically adjusting speed such as adaptive cruise control, automatic driving along a set route, and automatically setting a route when a destination is set. The vehicle covers vehicles equipped with internal combustion engines, hybrid vehicles equipped with internal combustion engines and electric motors, and electric vehicles equipped with electric motors, and may include trains, motorcycles, etc., as well as cars. Autonomous vehicles can be seen as robots with autonomous driving functions.

Extended reality is collectively referred to as VR, AR, and MR. VR technology provides objects and backgrounds of real world only through computer graphic (CG) images. AR technology provides a virtual CG image on top of a real object image. MR technology is a CG technology that combines and combines virtual objects into the real world. MR technology is similar to AR technology in that they show real and virtual objects together. However, there is a difference in that in AR technology, virtual objects are used as complementary forms to real objects, while in MR technology, virtual objects and real objects are used as equal personalities.

NR supports multiples numerologies (and/or multiple subcarrier spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., FR1 and FR2. The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter wave (mmW).

TABLE 1

| | | |
|---|---|---|
| Frequency Range designation | Corresponding frequency range | Subcarrier Spacing |
| FR1 | 450 MHz - 6000 MHz | 15, 30, 60 kHz |
| FR2 | 24250 MHz - 52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| | | |
|---|---|---|
| Frequency Range designation | Corresponding frequency range | Subcarrier Spacing |
| FR1 | 410 MHz - 7125 MHz | 15, 30, 60 kHz |
| FR2 | 24250 MHz - 52600 MHz | 60, 120, 240 kHz |

Here, the radio communication technologies implemented in the wireless devices in the present disclosure may include narrowband internet-of-things (NB—IoT) technology for low-power communication as well as LTE, NR and 6G. For example, NB-IoT technology may be an example of low power wide area network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate personal area networks (PANs) associated with small/low-power digital communication based on various specifications such as IEEE 802.15.4 and may be called various names.

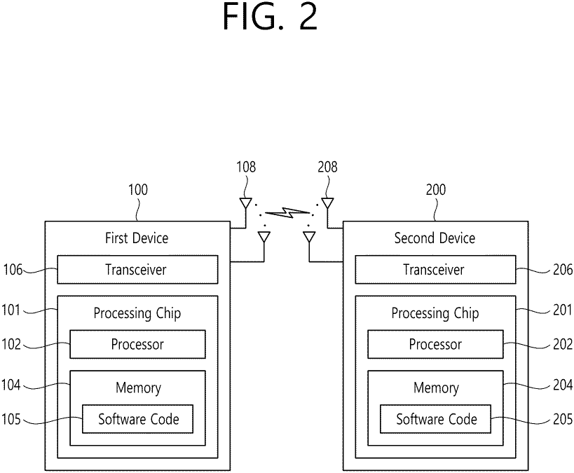

FIG. 2 shows an example of wireless devices to which implementations of the present disclosure is applied.

Referring to FIG. 2, a first wireless device 100 and a second wireless device 200 may transmit/receive radio signals to/from an external device through a variety of RATs (e.g., LTE and NR).

In FIG. 2, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. It is exemplarily shown in FIG. 2 that the memory 104 is included in the processing chip 101. Additional and/or alternatively, the memory 104 may be placed outside of the processing chip 101.

The processor 102 may control the memory 104 and/or the transceiver 106 and may be configured to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with radio frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. It is exemplarily shown in FIG. 2 that the memory 204 is included in the processing chip 201. Additional and/or alternatively, the memory 204 may be placed outside of the processing chip 201.

The processor 202 may control the memory 204 and/or the transceiver 206 and may be configured to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, media access control (MAC) layer, radio link control (RLC) layer, packet data convergence protocol (PDCP) layer, radio resource control (RRC) layer, and service data adaptation protocol (SDAP) layer). The one or more processors 102 and 202 may generate one or more protocol data units (PDUs) and/or one or more service data unit (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

In the implementations of the present disclosure, a UE may operate as a transmitting device in uplink (UL) and as a receiving device in downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

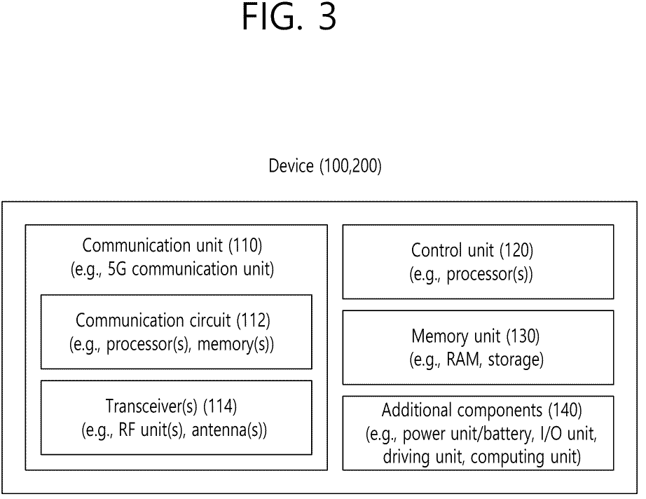

FIG. 3 shows an example of a wireless device to which implementations of the present disclosure is applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory unit 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, input/output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor (AP), an electronic control unit (ECU), a graphical processing unit, and a memory control processor. As another example, the memory unit 130 may be configured by a RAM, a DRAM, a ROM, a flash memory, a volatile memory, a non-volatile memory, and/or a combination thereof.

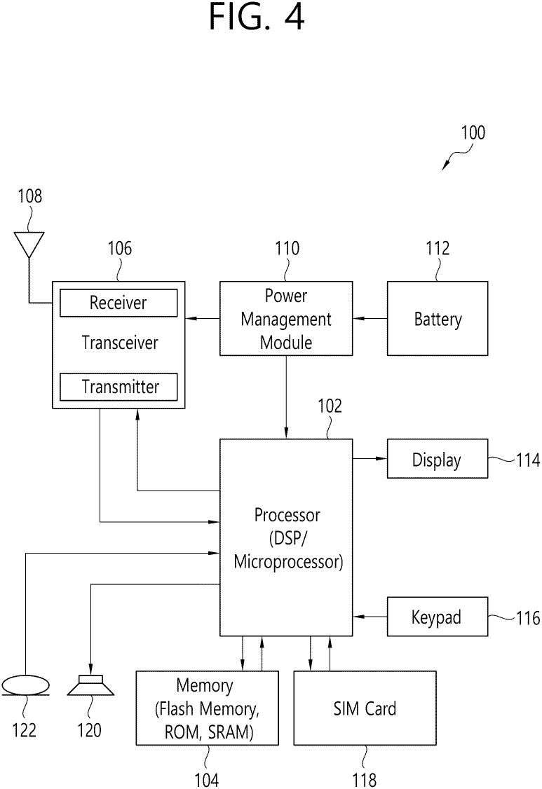

FIG. 4 shows an example of UE to which implementations of the present disclosure is applied.

Referring to FIG. 4, a UE 100 may correspond to the first wireless device 100 of FIG. 2 and/or the wireless device 100 or 200 of FIG. 3.

A UE 100 includes a processor 102, a memory 104, a transceiver 106, one or more antennas 108, a power management module 110, a battery 112, a display 114, a keypad 116, a subscriber identification module (SIM) card 118, a speaker 120, and a microphone 122.

The processor 102 may be configured to implement the descriptions, functions, procedures, suggestions, methods and/or operational flowcharts disclosed in the present disclosure. The processor 102 may be configured to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of a digital signal processor (DSP), a central processing unit (CPU), a graphics processing unit (GPU), a modem (modulator and demodulator). An example of the processor 102 may be found in SNAPDRAGONTM series of processors made by Qualcomm®, EXYNOSTM series of processors made by Samsung®, A series of processors made by Apple®, HELIOTM series of processors made by MediaTek®, ATOMTM series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 110 manages power for the processor 102 and/or the transceiver 106. The battery 112 supplies power to the power management module 110.

The display 114 outputs results processed by the processor 102. The keypad 116 receives inputs to be used by the processor 102. The keypad 116 may be shown on the display 114.

The SIM card 118 is an integrated circuit that is intended to securely store the international mobile subscriber identity (IMSI) number and its related key, which are used to identify and authenticate subscribers on mobile telephony devices (such as mobile phones and computers). It is also possible to store contact information on many SIM cards.

The speaker 120 outputs sound-related results processed by the processor 102. The microphone 122 receives sound-related inputs to be used by the processor 102.

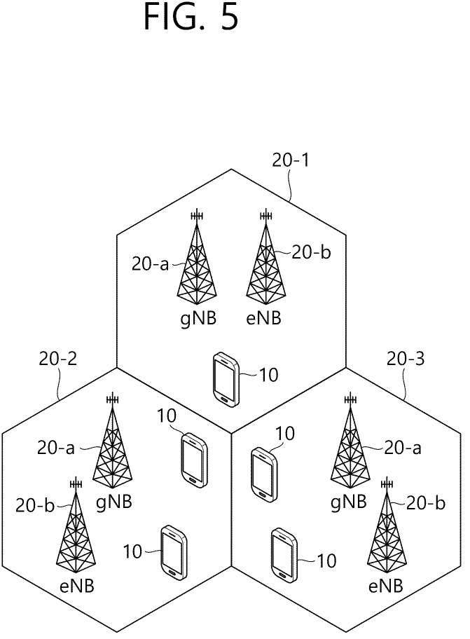

FIG. 5 is an example of a wireless communication system.

As can be seen with reference to FIG. 5, a wireless communication system includes at least one base station (BS). The BS is divided into a gNodeB (or gNB) 20a and an eNodeB (or an eNB) 20b. The gNB 20a supports 5G mobile communication. The eNB 20b supports 4G mobile communication, that is, long term evolution (LTE).

Each base station 20a and 20b provides a communication service for a specific geographic area (generally referred to as a cell) (20-1, 20-2, and 20-3). A cell may be again divided into a plurality of regions (referred to as sectors).

The UE generally belongs to one cell and the cell to which the UE belong is referred to as a serving cell. A base station that provides the communication service to the serving cell is referred to as a serving BS. Since the wireless communication system is a cellular system, another cell that neighbors to the serving cell is present. Another cell which neighbors to the serving cell is referred to a neighbor cell. A base station that provides the communication service to the neighbor cell is referred to as a neighbor BS. The serving cell and the neighbor cell are relatively decided based on the UE.

Hereinafter, a downlink means communication from the base station 20 to the UE 10 and an uplink means communication from the UE 10 to the base station 20. In the downlink, a transmitter may be a part of the base station 20 and a receiver may be a part of the UE 10. In the uplink, the transmitter may be a part of the UE 10 and the receiver may be a part of the base station 20.

Meanwhile, the wireless communication system may be generally divided into a frequency division duplex (FDD) type and a time division duplex (TDD) type. According to the FDD type, uplink transmission and downlink transmission are achieved while occupying different frequency bands. According to the TDD type, the uplink transmission and the downlink transmission are achieved at different time while occupying the same frequency band. A channel response of the TDD type is substantially reciprocal. This means that a downlink channel response and an uplink channel response are approximately the same as each other in a given frequency area. Accordingly, in the TDD based wireless communication system, the downlink channel response may be acquired from the uplink channel response. In the TDD type, since an entire frequency band is time-divided in the uplink transmission and the downlink transmission, the downlink transmission by the base station and the uplink transmission by the terminal may not be performed simultaneously. In the TDD system in which the uplink transmission and the downlink transmission are divided by the unit of a subframe, the uplink transmission and the downlink transmission are performed in different subframes.

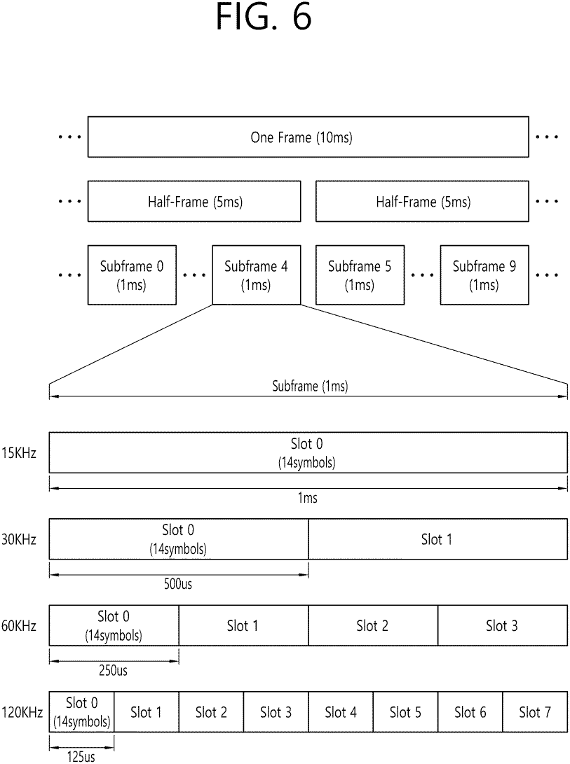

FIG. 6 illustrates a structure of a radio frame used in NR.

In NR, uplink and downlink transmission are composed of frames. The radio frame may have a length of 10 ms and may be defined as two 5-ms half-frames (HFs). Each half-frame may be defined as five 1-ms subframes (SFs). A subframe may be divided into one or more slots, and the number of slots in a subframe may depend on SCS (Subcarrier Spacing). Each slot may include 12 or 14 OFDM(A) symbols according to a cyclic prefix (CP). In some implementations, if a CP is used, then each slot contains 14 symbols. If an extended CP is used, then each slot contains 12 symbols. The symbol may include, for example, an OFDM symbol (or a CP-OFDM symbol) and an SC-FDMA symbol (or a DFT-s-OFDM symbol.

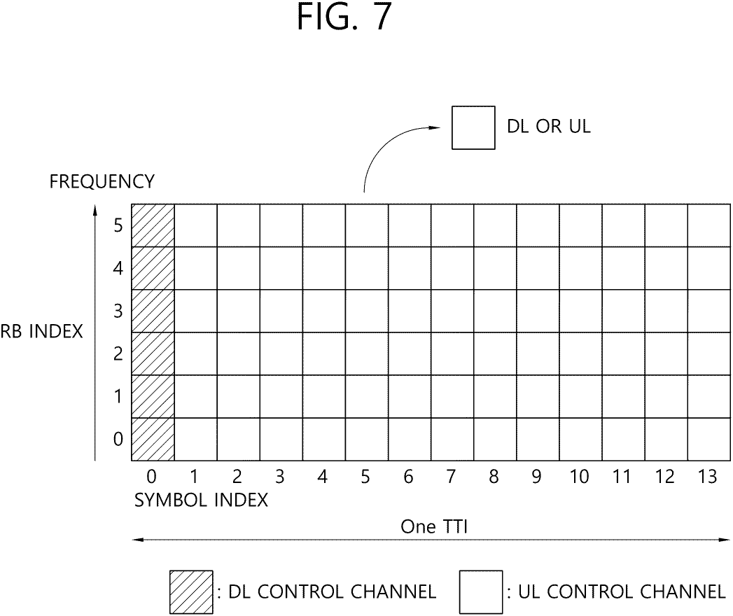

FIG. 7 shows an example of subframe type in NR.

A transmission time interval (TTI) shown in FIG. 7 may be called a subframe or slot for NR (or new RAT). The subframe (or slot) in FIG. 7 may be used in a TDD system of NR (or new RAT) to minimize data transmission delay. As shown in FIG. 7, a subframe (or slot) includes 14 symbols as does the current subframe. A front symbol of the subframe (or slot) can be used for a downlink control channel, and a rear symbol of the subframe (or slot) can be used for an uplink control channel. Other channels can be used for downlink data transmission or uplink data transmission. According to such structure of a subframe (or slot), downlink transmission and uplink transmission may be performed sequentially in one subframe (or slot). Therefore, a downlink data may be received in the subframe (or slot), and an uplink acknowledge response (ACK/NACK) may be transmitted in the subframe (or slot).

A subframe (or slot) in this structure may be called a self-constrained subframe.

Specifically, first N symbols in a slot may be used to transmit a DL control channel (hereinafter, DL control region), and last M symbols in a slot may be used to transmit a UL control channel (hereinafter, UL control region). N and M are each an integer greater than or equal to 0. A resource region (hereinafter, referred to as a data region) between the DL control region and the UL control region can be used for DL data transmission or for UL data transmission. For example, a PDCCH may be transmitted in the DL control region and the PDSCH may be transmitted in the DL data region. A PUCCH may be transmitted in the UL control region, and a PUSCH may be transmitted in the UL data region.

If this structure of a subframe (or slot) is used, it may reduce time required to retransmit data regarding which a reception error occurred, and thus, a final data transmission waiting time may be minimized. In such structure of the self-contained subframe (slot), a time gap may be required for transition from a transmission mode to a reception mode or vice versa. To this end, when downlink is transitioned to uplink in the subframe structure, some OFDM symbols may be set as a Guard Period (GP).

### Support of Various Numerology

In a next system, a plurality of numerologies may be provided to a terminal according to the development of wireless communication technology. For example, when SCS is 15 kHz, it supports a wide area in traditional cellular bands, and when SCS is 30 kHz/60 kHz, it supports a dense-urban, lower latency and wider carrier bandwidth, and when SCS is 60 kHz or higher, it supports a bandwidth greater than 24.25 GHz to overcome phase noise.

The numerology may be defined by a cycle prefix (CP) length and a subcarrier spacing (SCS). One cell may provide a plurality of numerologies to the terminal. When an index of numerology is expressed as µ, an interval of each subcarrier and a corresponding CP length may be as shown in the table below.

TABLE 3

| µ | Δf=2^{µ}·15 [kHz] | CP |
|---|---|---|
| 0 | 15 | normal |
| 1 | 30 | normal |
| 2 | 60 | normal, extended |
| 3 | 120 | normal |
| 4 | 240 | normal |

In the case of normal CP, when an index of numerology is expressed as µ, the number (N^{slot}_{symb}) of OFDM symbols per slot, the number of slots (N^{frame,µ}ₛₗₒₜ) per frame, and the number (N^{subframe,µ}ₛₗₒₜ) of slots per subframe are shown in the table below.

TABLE 4

| µ | N^{slot}ₛ_{y}_{mb} | N^{frame,µ}ₛₗₒₜ | N^{subframe,µ}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

In the case of extended CP, when the index of numerology is expressed as µ, the number (N^{slot}_{symb}) of OFDM symbols per slot, the number (N^{frame,µ}ₛₗₒₜ) of slots per frame, and the number (N^{subframe,µ}ₛₗₒₜ) of slots per subframe are shown in the table below.

TABLE 5

| µ | N^{slot}_{symb} | N^{frame,µ}ₛₗₒₜ | N^{subframe,µ}ₛₗₒₜ |
|---|---|---|---|
| 2 | 12 | 40 | 4 |

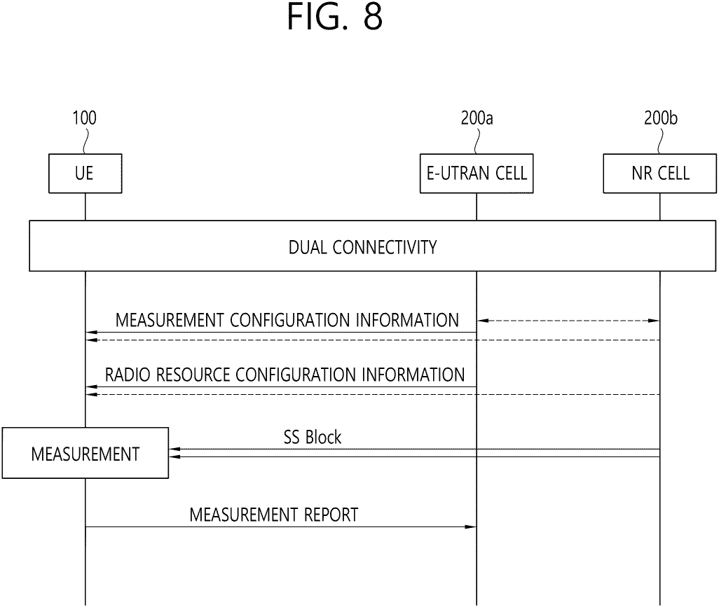

FIG. 8 shows an example of performing measurement in E-UTRAN and NR (EN) DC case.

Referring to FIG. 8, the UE 100 are connected in EN-DC with an E-UTRAN (that is, LTE/LTE-A) cell. Here, a Pcell in EN-DC may be an E-UTRAN (that is, LTE/LTE-A) cell, and a PSCell in EN-DC may be an NR cell.

The UE 100 may receive measurement configuration (or “measconfig”) information element (IE) of the E-UTRAN (that is, LTE/LTE-A) cell. The measurement configuration (or “measconfig”) IE received from the E-UTRAN (that is, LTE/LTE-A) cell may further include fields shown in the following table, in addition to the fields shown in Table 6.

TABLE 6

MeasConfig field description
fr1-Gap
This field exists when a UE is configured with EN-DC. This field indicates whether a gap is applied to perform measurement on FR1 band

MeasConfig field description
mgta
It indicates whether to apply a timing advance (TA) of 0.5 ms for a measurement gap configuration provided by the E-UTRAN.

The measurement configuration (or “measconfig”) IE may further include a measGapConfig field for setting a measurement gap (MG), as shown in Table 7.

A gapoffset field within the measGapConfig field may further include gp4, gp5, ..., gp11 for EN-DC, in addition to the example shown in Table 8.

Meanwhile, the UE 100 may receive a measurement configuration (“measconfig”) IE of an NR cell, which is a PSCell, directly from the NR cell or through the E-UTRAN cell which is a Pcell.

Meanwhile, the measurement configuration (“measconfig”) IE of the NR cell may include fields as shown in the following table.

TABLE 7

MeasConfig field description
measGapConfig
It indicates configuration or cancelation of a measurement gap

s-MeasureConfig
It indicates a threshold value for measurement of NR SpCell RSRP when a UE needs to perform measurement on a non-serving cell.

The above measGapConfig may further include fields as shown in the following table.

TABLE 8

MeasGapConfig field description

gapFR2
It indicates a measurement gap configuration applicable for FR2 frequency range.

gapOffset
It indicates a gap offset of a gap pattern with an MGRP.

mgl
It indicates a measurement gap length by ms. There may be 3 ms, 4 ms, 6 ms, etc.

mgrp
It indicates a measurement gap repetition period by ms.

mgta
It indicates whether to apply a timing advance (TA) of 0.5 ms for a measurement gap configuration.

Meanwhile, the UE 100 receives a radio resource configuration information element (IE) of the E-UTRAN (that is, LTE/LTE-A) cell which is a Pcell. In addition, the UE may receive a radio resource configuration IE of an NR cell, which is a PSCell, from the NR cell or through the E-UTRAN cell which is a Pcell. The radio resource configuration IE includes subframe pattern information.

The UE 100 performs measurement and reports a measurement result. Specifically, the UE 100 interrupts data transmission and reception with the E-UTRAN (that is, LTE/LTE-A) cell during the measurement gap, retunes its own RF chain, and performs measurement based on receipt of an SS block from an NR cell.

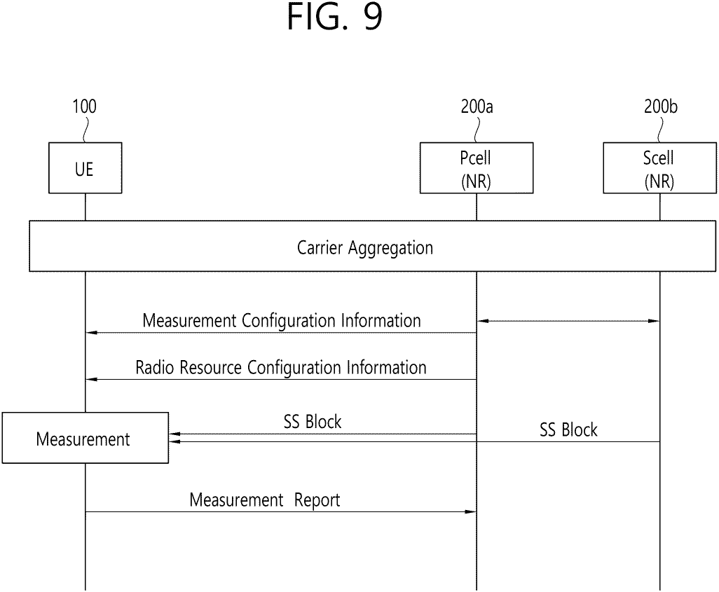

FIG. 9 shows an example of performing measurement in NR carrier aggregation case.

Referring to FIG. 9, the UE 100 is configured for a carrier aggregation with a first cell (e.g, Pcell) and a second cell (e.g Scell). Here, the Pcell may be an NR based cell, and the Scell may be an NR based cell.

The UE 100 may receive measurement configuration (or “measconfig”) information element (IE). The measurement configuration (or “measconfig”) IE may include fields shown in the above tables.

The UE 100 receives a radio resource configuration information element (IE). The UE 100 performs measurement and reports a measurement result.

### Cell Re-Selection

The cell reselection procedure allows the UE to select a more suitable cell and camp on it.

When the UE is in either Camped Normally state or Camped on Any Cell state on a cell, the UE shall attempt to detect, synchronize, and monitor intra-frequency, inter-frequency and inter-RAT cells indicated by the serving cell. For intra-frequency and inter-frequency cells, the serving cell may not provide explicit neighbor list but carrier frequency information and bandwidth information only. UE measurement activity is also controlled by measurement rules, allowing the UE to limit its measurement activity.

For idle mode cell re-selection purposes, the UE shall be capable of monitoring at least:
Intra-frequency carrier, and
Depending on UE capability, 7 NR inter-frequency carriers, and
Depending on UE capability, 7 FDD E-UTRA inter-RAT carriers, and
Depending on UE capability, 7 TDD E-UTRA inter-RAT carriers.

In addition to the requirements defined above, a UE supporting E-UTRA measurements in RRC_IDLE state shall be capable of monitoring a total of at least 14 carrier frequency layers, which includes serving layer, comprising of any above defined combination of E-UTRA FDD, E-UTRA TDD and NR layers.

The UE shall measure the SS-RSRP and SS-RSRQ level of the serving cell and evaluate the cell selection criterion S for the serving cell at least once every M1*N1 DRX cycle.

The UE shall filter the SS-RSRP and SS-RSRQ measurements of the serving cell using at least 2 measurements. Within the set of measurements used for the filtering, at least two measurements shall be spaced by, at least DRX cycle/2.

If the UE has evaluated according to Table 9 in Nₛₑᵣᵥ consecutive DRX cycles that the serving cell does not fulfil the cell selection criterion S, the UE shall initiate the measurements of all neighbor cells indicated by the serving cell, regardless of the measurement rules currently limiting UE measurement activities.

If the UE in RRC_IDLE has not found any new suitable cell based on searches and measurements using the intra-frequency, inter-frequency and inter-RAT information indicated in the system information for 10 s, the UE shall initiate cell selection procedures for the selected PLMN.

TABLE 9

| DRX cycle length [s] | Scaling Factor (N1) | | Nₛₑᵣᵥ [number of DRX cycles] |
|---|---|---|---|
| | FR1 | FR2^{Note1} | |
| 0.32 | 1 | 8 | M1*N1*4 |
| 0.64 | | 5 | M1*N1*4 |
| 1.28 | | 4 | N1*2 |
| 2.56 | | 3 | N1*2 |

Note 1: Applies for UE supporting power class 2&3&4. For UE supporting power class 1, N1 = 8 for all DRX cycle length.

The UE shall be able to identify new intra-frequency cells and perform SS-RSRP and SS-RSRQ measurements of the identified intra-frequency cells without an explicit intra-frequency neighbor list containing physical layer cell identities.

The UE shall be able to evaluate whether a newly detectable intra-frequency cell meets the reselection criteria within T_{detect,NR_Intra} when that Treselection= 0 . An intra frequency cell is considered to be detectable according to the conditions for a corresponding Band.

The UE shall measure SS-RSRP and SS-RSRQ at least every T_{measure,NR_Intra} (see table 10) for intra-frequency cells that are identified and measured according to the measurement rules.

The UE shall filter SS-RSRP and SS-RSRQ measurements of each measured intra-frequency cell using at least 2 measurements. Within the set of measurements used for the filtering, at least two measurements shall be spaced by at least T_{measure,NR_Intra}/2.

The UE shall not consider a NR neighbor cell in cell reselection, if it is indicated as not allowed in the measurement control system information of the serving cell.

For an intra-frequency cell that has been already detected, but that has not been reselected to, the filtering shall be such that the UE shall be capable of evaluating that the intra-frequency cell has met reselection criterion defined [1] within T_{evaluate,NR_Intra} when Treselection = 0 as specified in table 10 provided that:
when rangeToBestCell is not configured:
   the cell is at least 3 dB better ranked in FR1 or 4.5 dB better ranked in FR2.
when rangeToBestCell is configured:
   the cell has the highest number of beams above the threshold absThreshSS-BlocksConsolidation among all detected cells whose cell-ranking criterion R value is within rangeToBestCell of the cell-ranking criterion R value of the highest ranked cell.
   if there are multiple such cells, the cell has the highest rank among them.
   the cell is at least 3 dB better ranked in FR1 or [4.5]dB better ranked in FR2 if the current serving cell is among them.

When evaluating cells for reselection, the SSB side conditions apply to both serving and non-serving intra-frequency cells.

If Treselection timer has a non zero value and the intra-frequency cell is satisfied with the reselection criteria, the UE shall evaluate this intra-frequency cell for the Treselection time. If this cell remains satisfied with the reselection criteria within this duration, then the UE shall reselect that cell.

TABLE 10

| DRX cycle length [s] | Scaling Factor (N1) | | T_{detect,NR_Intra} [s] (number of DRX cycles) | T_{measure,NR_Intra} [s] (number of DRX cycles) | T_{evaluate,NR}_{_}_{Intra} [s] (number of DRX cycles) |
|---|---|---|---|---|---|
| | FR1 | FR2^{Note1} | | | |
| 0.32 | 1 | 8 | 11.52 × N1 × M2 (36 × N1 × M2) | 1.28 × N1 × M2 (4 × N1 × M2) | 5.12 × N1 × M2 (16 × N1 × M2) |
| 0.64 | | 5 | 17.92 × N1 (28 × N1) | 1.28 × N1 (2 × N1) | 5.12 × N1 (8 N1) × |
| 1.28 | | 4 | 32 × N1 (25 × N1) | 1.28 × N1 (1 × N1) | 6.4 × N1 (5 × N1) |
| 2.56 | | 3 | 58.88 × N1 (23 × N1) | 2.56 × N1 (1 × N1) | 7.68 × N1 (3 × N1) |

Note 1: Applies for UE supporting power class 2&3&4. For UE supporting power class 1, N1 = 8 for all DRX cycle length. Note 2: M2 = 1.5 if SMTC periodicity of measured intra-frequency cell > 20 ms; otherwise M2=1.

The UE shall be able to identify new inter-frequency cells and perform SS-RSRP or SS-RSRQ measurements of identified inter-frequency cells if carrier frequency information is provided by the serving cell, even if no explicit neighbor list with physical layer cell identities is provided.

If Srxlev > S_{nonIntraSearchP} and Squal > S_{nonIntraSearchQ} then the UE shall search for inter-frequency layers of higher priority at least every Thigher_priority_search.

If Srxlev ≤ S_{nonIntraSearchP} or Squal ≤ S_{nonIntraSearchQ} then the UE shall search for and measure inter-frequency layers of higher, equal or lower priority in preparation for possible reselection. In this scenario, the minimum rate at which the UE is required to search for and measure higher priority layers shall be the same as that defined below in this clause.

The UE shall be able to evaluate whether a newly detectable inter-frequency cell meets the reselection criteria within K_{carrier} * T_{detect,NR_Inter} if at least carrier frequency information is provided for inter-frequency neighbor cells by the serving cells when T_{reselection} = 0 provided that the reselection criteria is met by a margin of at least 5 dB in FR1 or 6.5 dB in FR2 for reselections based on ranking or 6 dB in FR1 or 7.5 dB in FR2 for SS-RSRP reselections based on absolute priorities or 4 dB in FR1 and 4 dB in FR2 for SS-RSRQ reselections based on absolute priorities. The parameter K_{carrier} is the number of NR inter-frequency carriers indicated by the serving cell. An inter-frequency cell is considered to be detectable according to the conditions for a corresponding Band.

When higher priority cells are found by the higher priority search, they shall be measured at least every T_{measure,NR_Inter}. If, after detecting a cell in a higher priority search, it is determined that reselection has not occurred then the UE is not required to continuously measure the detected cell to evaluate the ongoing possibility of reselection. However, the minimum measurement filtering requirements specified later in this clause shall still be met by the UE before it makes any determination that it may stop measuring the cell. If the UE detects on a NR carrier a cell whose physical identity is indicated as not allowed for that carrier in the measurement control system information of the serving cell, the UE is not required to perform measurements on that cell.

The UE shall measure SS-RSRP or SS-RSRQ at least every K_{carrier} * T_{measure,NR_Inter} (see table 11) for identified lower or equal priority inter-frequency cells. If the UE detects on a NR carrier a cell whose physical identity is indicated as not allowed for that carrier in the measurement control system information of the serving cell, the UE is not required to perform measurements on that cell.

The UE shall filter SS-RSRP or SS-RSRQ measurements of each measured higher, lower and equal priority inter-frequency cell using at least 2 measurements. Within the set of measurements used for the filtering, at least two measurements shall be spaced by at least T_{measure,NR_Inter}/2.

The UE shall not consider a NR neighbor cell in cell reselection, if it is indicated as not allowed in the measurement control system information of the serving cell.

For an inter-frequency cell that has been already detected, but that has not been reselected to, the filtering shall be such that the UE shall be capable of evaluating that the inter-frequency cell has met reselection criterion within Kcarrier * T_{evaluate,NR_Inter} when Treselection = 0 provided that the reselection criteria is met by
the condition when performing equal priority reselection and when rangeToBestCell is not configured:
the cell is at least 5 dB better ranked in FR1 or 6.5 dB better ranked in FR2 or. when rangeToBestCell is configured:
the cell has the highest number of beams above the threshold absThreshSS-BlocksConsolidation among all detected cells whose cell-ranking criterion R value is within rangeToBestCell of the cell-ranking criterion R value of the highest ranked cell.
   if there are multiple such cells, the cell has the highest rank among them
   the cell is at least 5 dB better ranked in FR1 or [6.5]dB better ranked in FR2 if the current serving cell is among them. or
6 dB in FR1 or 7.5 dB in FR2 for SS-RSRP reselections based on absolute priorities or
4 dB in FR1 or 4 dB in FR2 for SS-RSRQ reselections based on absolute priorities.

When evaluating cells for reselection, the SSB side conditions apply to both serving and inter-frequency cells.

If T_{reselection} timer has a non zero value and the inter-frequency cell is satisfied with the reselection criteria, the UE shall evaluate this inter-frequency cell for the T_{reselection} time. If this cell remains satisfied with the reselection criteria within this duration, then the UE shall reselect that cell.

The UE is not expected to meet the measurement requirements for an inter-frequency carrier under DRX cycle=320 ms under the following conditions:
T_{SMTC_intra} = T_{SMTC_inter}= 160 ms; where T_{SMTC_intra} and T_{SMTC_inter} are periodicities of the SMTC occasions configured for the intra-frequency carrier and the inter-frequency carrier respectively, and
SMTC occasions configured for the inter-frequency carrier occur up to 1 ms before the start or up to 1 ms after the end of the SMTC occasions configured for the intra-frequency carrier, and
SMTC occasions configured for the intra-frequency carrier and for the inter-frequency carrier occur up to 1 ms before the start or up to 1 ms after the end of the paging occasion [1].

TABLE 11

| DRX cycle length [s] | Scaling Factor (N1) | | T_{detect,NR_Inter} [s] (number of DRX cycles) | T_{measure,NR_Inter} [s] (number of DRX cycles) | T_{evaluate,NR_Inter} [s] (number of DRX cycles) |
|---|---|---|---|---|---|
| | FR1 | FR2Note1 | | | |
| 0.32 | 1 | 8 | 11.52 × N1 × 1.5 (36 × N1 × 1.5) | 1.28 × N1 × 1.5 (4 × N1 × 1.5) | 5.12 × N1 × 1.5 (16 × N1 × 1.5) |
| 0.64 | | 5 | 17.92 × N1 (28 × N1) | 1.28 × N1 (2 × N1) | 5.12 × N1 (8 N1) × |
| 1.28 | | 4 | 32 × N1 (25 × N1) | 1.28 × N1 (1 × N1) | 6.4 × N1 (5 × N1) |
| 2.56 | | 3 | 58.88 × N1 (23 × N1) | 2.56 × N1 (1 × N1) | 7.68 × N1 (3 × N1) |

Note 1: Applies for UE supporting power class 2&3&4. For UE supporting power class 1, N1 = 8 for all DRX cycle length.

Based on serving cell signal quality, UE may measure neighbor cell for cell selection or reselection.

If the serving cell fulfils Sᵣₓₗₑᵥ > S_{IntraSearchP} and S_{qual} > S_{IntraSearchQ}, the UE may choose not to perform intra-frequency measurements. Otherwise, the UE may perform intra-frequency measurements.

Sᵣₓₗₑᵥ is cell selection RX level value (dB). S_{qual} is cell selection quality value (dB). S_{IntraSearchP} specifies the Sᵣₓₗₑᵥ threshold (in dB) for intra-frequency measurements. S_{IntraSearchQ} specifies the Squal threshold (in dB) for intra-frequency measurements

### Non-Terrestrial Networks

A non-terrestrial network refers to a network, or segment of networks using RF resources on board a satellite (or UAS platform).

The typical scenario of a non-terrestrial network providing access to user equipment is depicted below.

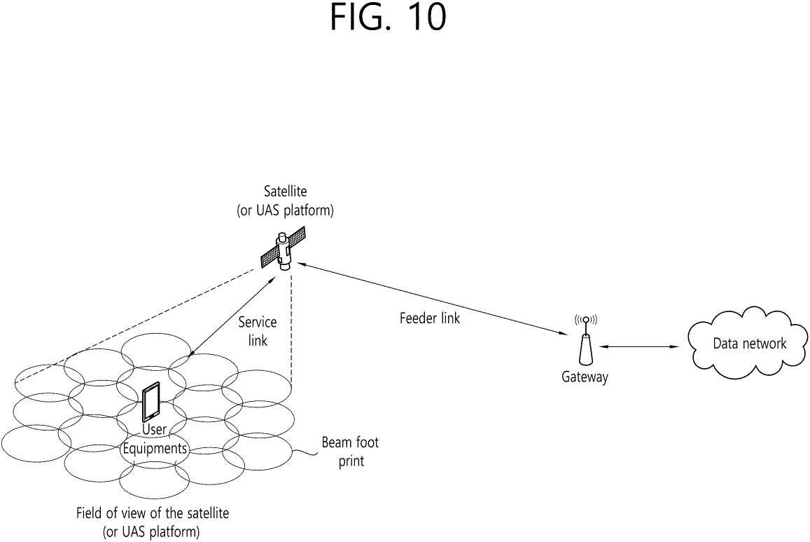

FIG. 10 shows Non-terrestrial network typical scenario based on transparent payload.

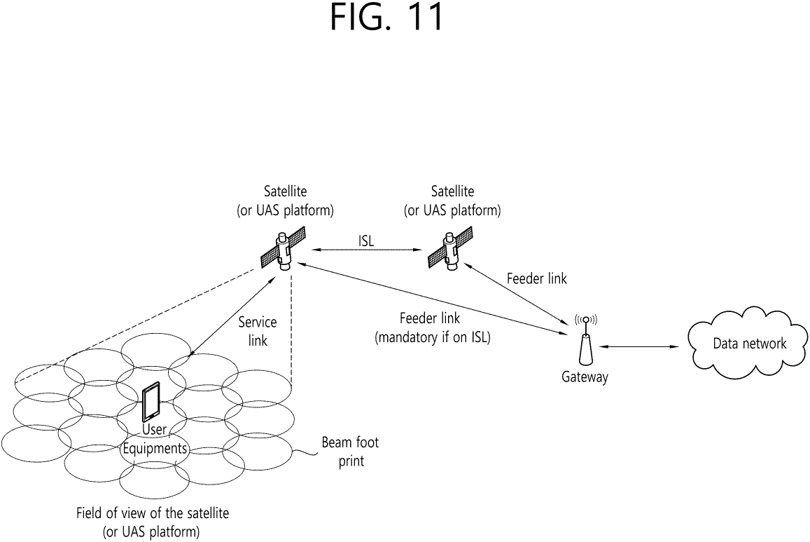

FIG. 11 shows Non-terrestrial network typical scenario based on regenerative payload.

Non-Terrestrial Network typically features the following elements:
One or several sat-gateways that connect the Non-Terrestrial Network to a public data network
A GEO satellite is fed by one or several sat-gateways which are deployed across the satellite targeted coverage (e.g. regional or even continental coverage). We assume that UE in a cell are served by only one sat-gateway
A Non-GEO satellite served successively by one or several sat-gateways at a time. The system ensures service and feeder link continuity between the successive serving sat-gateways with sufficient time duration to proceed with mobility anchoring and hand-over
A Feeder link or radio link between a sat-gateway and the satellite (or UAS platform)
A service link or radio link between the user equipment and the satellite (or UAS platform).
A satellite (or UAS platform) which may implement either a transparent or a regenerative (with on board processing) payload. The satellite (or UAS platform) generate beams typically generate several beams over a given service area bounded by its field of view. The footprints of the beams are typically of elliptic shape. The field of view of a satellites (or UAS platforms) depends on the on board antenna diagram and min elevation angle.
A transparent payload: Radio Frequency filtering, Frequency conversion and amplification. Hence, the waveform signal repeated by the payload is un-changed;
A regenerative payload: Radio Frequency filtering, Frequency conversion and amplification as well as demodulation/decoding, switch and/or routing, coding/modulation. This is effectively equivalent to having all or part of base station functions (e.g. gNB) on board the satellite (or UAS platform).
Inter-satellite links (ISL) optionally in case of a constellation of satellites. This will require regenerative payloads on board the satellites. ISL may operate in RF frequency or optical bands.
User Equipment are served by the satellite (or UAS platform) within the targeted service area.

There may be different types of satellites (or UAS platforms) listed here under: Table 12 shows Types of NTN platforms.

TABLE 12

| | | | |
|---|---|---|---|
| Platforms | Altitude range | Orbit | Typical beam footprint size |
| Low-Earth Orbit (LEO) satellite | 300 - 1500 km | Circular around the earth | 100-1000 km |
| Medium-Earth Orbit (MEO) satellite | 7000 - 25000 km | | 100-1000 km |
| Geostationary Earth Orbit (GEO) satellite | 35 786 km | notional station keeping position fixed in terms of elevation/azimuth with respect to a given earth point | 200-3500 km |
| UAS platform (including HAPS) | 8 - 50 km (20 km for HAPS) | | 5 - 200 km |
| High Elliptical Orbit (HEO) satellite | 400 - 50000 km | Elliptical around the earth | 200-3500 km |

GEO satellite and UAS are used to provide continental, regional or local service.

A constellation of LEO and MEO is used to provide services in both Northern and Southern hemispheres. In some case, the constellation can even provide global coverage including polar regions. For the later, this requires appropriate orbit inclination, sufficient beams generated and inter-satellite links.

### Problems to Be Solved in the Disclosure of This Specification

The NTN environment is expected to have a very large cell radius, and low service quality due to large path loss. That is, the UE may receive a higher quality service in the TN cell than in the NTN cell. Therefore, when the NTN cell and the TN cell compete for reselection of the UE, there is a need for a method for allowing the UE to easily receive a service from the TN cell.

When the NTN cell and the TN cell compete for reselection according to the conventional standard, the following situation may occur.
According to the reselection result, the UE may be served by the NTN cell. However, if served by a TN cell, the UE may be provided with better service quality than the NTN cell.

Furthermore, in configuring the search period for the TN cell in relation to reselection, there is a problem that the distance from the TN cell, the signal strength from the TN cell and the remaining service time with the current service satellite (etc.) are not considered.

### Disclosure of the Present Specification

5G NR NTN (non-terrestrial network) was introduced in order for a UE to receive a communication service using a satellite/aircraft, etc. in a coverage hall of an existing terrestrial network (TN). The present specification deals with a method of configuring a serving cell with a high priority according to the RRC state or location of an NTN-supporting terminal, a method for searching/measuring a high-priority cell, a method for selecting a high-priority cell, and the like. For explanation, there are NTN to TN mobility example that can be used in an environment where NTN and TN are mixed (region where both satellite and terrestrial base station signals can be searched) and the NTN to NTN example in NTN environment (area where only satellite signals can be searched). The each examples are described separately, but each method in examples can be similarly applied in different environments.

Even for a UE that supports NTN, it is recommended to receive the service from the base station of the terrestrial network in order to secure a high data rate or connection stability because the distance between the satellite and the UE is much larger than the distance between the base station of the terrestrial network and the UE.

However, it may be an inefficient operation for a UE receiving a service from a satellite to periodically search for/measure a terrestrial base station in an area (e.g., desert, high seas, etc.) where no signals are received from the terrestrial base station. This may increase battery consumption of the UE.

In summary, since it is better to receive service from a terrestrial base station for a UE whose serving cell is a NTN satellite, it is necessary for the UE to periodically search for/measure a terrestrial base station. However, searching/measuring too frequently is an inefficient operation that increases battery consumption of the UE.

Therefore, the priorities of TN and NTN may be determined in consideration of the location and status of the UE. An operation of a UE supporting both NTN and TN may be as follows:
a. If the UE belonging to the NR TN coverage also is able to support the NTN communication
   If the UE is configured to perform NR communication and not perform NR NTN communication, the UE may consider the frequency providing NR TN communication configuration to be the highest priority.
b. If the UE in NTN coverage is very far from TN coverage (e.g. high seas, inflight, etc.)
   If the UE is configured to perform NR NTN communication and not perform NR communication, the UE may consider the frequency providing NR NTN communication configuration to be the highest priority.
c. If a UE is located at a distance by a certain defined distance from the NR NTN coverage edge and the TN coverage edge
   If the UE is configured to perform both NR communication and NR NTN communication, the UE may consider the frequency providing NR TN communication configuration to be the higher priority than frequency providing NR NTN communication.
d. etc.
   If the UE is configured to perform both NR communication and NR NTN communication, the UE may consider the frequency providing both NR communication configuration and NR NTN communication configuration to be the highest priority.

In the above operation, if a specific system has a very high priority, it may be restricted not to measure a system with a low priority. For example, in the case of a, the UE located in the center of the TN coverage is limited not to measure the NTN, so that the UE can only measure the TN. In the case of b, the UE may restrict the UE not to measure the TN, so that the UE only measures the NTN.

Conditions when the TN cell has a higher priority may be as follows, and may be used individually or in combination.

Condition 1. When the UE receives a signal from the TN cell to be measured preferentially through system information.

Condition 2. When the UE measures the distance to the TN cell based on the location of the TN cell received through system information (in case of receiving a separate signal through orbit information of NTN), and it is determined that the distance is less than or equal to a specific distance (e.g., the service radius of the TN base station, or a multiple thereof).

Condition 3. When the UE receives the reference locations of NTN satellites through system information, but there are no satellites that are less than a specific distance (i.e., there are no satellites sufficient to receive service).

Condition 4. When the UE receives the remaining service time of (serving or serving + neighbor) NTN satellites through system information, but there is no satellite with sufficient service time (i.e., there are not enough satellites to receive service).

Conditions when the TN cell has lower priority may be as follows.

Condition 5. When it is determined that there is no TN base station nearby because the location of the terminal is higher than a specific altitude (e.g. 1 km).

Condition 6. If the UE determines that its location is in the same place as the high seas, the terminal may determine that there is no TN base station nearby and set the priority for the TN cell to lower. At this time, the UE may determine that the UE is located in the coverage hole of the TN base station (e.g., the high seas), based on the information received from the network. Alternatively, the UE may determine that the UE is located in the coverage hole of the TN base station, based on the reference location or coverage information of the currently serving satellite. The UE may determine that there is no intra-frequency TN base station near the reference location of the intra-frequency satellite received from the network due to interference or the like. Then, the UE may set the priority for the intra frequency TN base station to lower (or equal according to the distance). Similarly, the UE may determine that there is no inter-frequency TN base station near the reference location of the inter-frequency satellite received from the network. Then, the UE may set the priority for the intra frequency TN base station to lower (or equal according to the distance).

Condition 7. When the UE does not find/measure a suitable cell even though the UE searches/measures a high priority TN cell for a specific time.

After priority of the TN cell is configured as above, the measurement operation according to the state of the UE may be as follows. In the following description, operation of the UE are divided according to the state of the UE for convenience, but each operation is applicable even when the UE is in a different state from described state.

### 1. When the UE is in Idle/Inactive Mode

### A. A Method for the UE to Search TN Cell

1) In the existing TN network, if the specific conditions are satisfied, the UE may not perform intra-frequency measurement.

If the serving cell fulfils Srxlev > S_{IntraSearchP} and Squal > S_{IntraSearchQ}, the UE may choose not to perform intra-frequency measurements.

1 However, the NTN UE may periodically attempt TN cell measurement for every T_{higher_priority_search} time for measuring intra-frequency TN cell set to a higher priority. In this case, T_{higher_priority_search} may be defined as:

$${\text{T}}_{\text{higher\_priority\_search}} = \text{(K} ∗ \text{N layers ) seconds}$$

The N layers is the total number of higher priority NR and E-UTRA carrier frequencies broadcasted in system information.

Here, K may vary depending on the distance between the UE and the TN network, or the network may transmit K to the UE. Alternatively, the UE may adjust K considering i) strength of signal from the TN network, ii) distance from the TN network and iii) remaining time of current service satellite. If the K is not set, values such as 60 and 120 may be set as default for K.

1 It may be considered that the search for the intra cell is triggered by satisfying another condition rather than a constant measurement. The search for the intra cell may be triggered when one of the following conditions is satisfied or a combination of the following conditions is satisfied.
i. Constant measurement without any conditions
ii. When the distance between the reference location of the cell to be searched and the UE is less than a certain value
iii. When there is information in the searchable TNcell in the network System information
iv. When the network designates a TN cell to search
v. When the remaining service time of the current cell becomes less than or equal to a specific value (if measurement is started when the remaining service time is T, discovery may be triggered at a time earlier than T).

2) In the existing TN network, if the following conditions are satisfied, the UE may measure a higher priority inter-frequency layer/inter-RAT E-UTRAN for every T_{higher_priority_search}.

If Srxlev > S_{nonIntraSearchP} and Squal > S_{nonIntraSearchQ}, then the UE may search for inter-frequency layers of higher priority at least every T_{higher_priority_search}.

T_{higher_priority_search} may be defined as:

$${\text{T}}_{\text{higher\_priority\_search}} = \text{(60} ∗ \text{N layers ) seconds}$$

The N layers is the total number of higher priority NR and E-UTRA carrier frequencies broadcasted in system information.

However, since it is efficient for the NTN UE to change the measurement period according to the distance from the base station, etc., it is proposed to use the value K for TN cell search instead of 60 as in 1), where K is the same as in 1). The K value may vary depending on the distance to the TN network, etc. The NW may transmit K value to the UE in consideration of the location of the UE. By setting a threshold value for the signal strength from the TN, the distance from the TN, or the remaining time with the current service satellite, the UE may perform measurement relaxation. If not specifically set, values such as 60 and 120 may be set as default for K.

The methods of 1) and 2) above are applicable not only to the TN cell but also to the search for the NTN cell.

T_{higher_priority_search} in 1) and 2) may be used as one value in NTN.

Different K values may be configured for NTN and TN cells. K value for TN (or NTN) cell may be different from K value for another TN (or NTN) cell. That is, it is possible to configure a different search time for different cells.

After the discovery process, the UE may measure the cell at every measurement period.

The method of the A may be described with a series of operation examples as follows. (Higher priority search method in NTN)

1 step. The UE may receive frequency priority (e.g., through signaling such as cellReselectionPrioity) in order to prepare for discovery/measurement.

2 step. The UE may perform the following operation based on the received measurement information and priority.

i. Intra-frequency measurement: In the existing operation, if Srxlev > S_{IntraSearchP} and Squal > S_{IntraSearchQ} is satisfied, intra-frequency measurement may not be searched. However, in this specification, for reselection to TN-cell or reselection to NTN cell, the UE may perform discovery operation with a period of (K*N layers).

ii. Inter-frequency measurement: In the existing operation, a higher priority frequency is searched with a period of (60* N layers) seconds. However, in this specification, the UE may perform discovery operation with a period of (K*N layers) instead of (60* N layers).

iii. At this time, K may vary according to the remaining service time of the serving cell and distance from the reference location. For example, if the service time of the serving is sufficient or the distance to the reference location of the serving cell is close, K greater than 60 may be used. In the opposite case, K smaller than 60 may be used to search the cell more frequently.

3 step. The UE may determine the signal strength of the neighboring cells through discovery/measurement/evaluation.

### B. Cell Selection/Rank Setting Method of UE

When the target cell satisfies a certain margin, the UE may reselect the target cell. By adjusting the certain margin, reselection between the TN cell and the NTN cell can be made difficult or easy. For example, if the margin that must be satisfied for the TN cell is lowered when a UE reselects a cell from an NTN cell to a TN cell, the possibility of the UE to reselect to the TN cell may be increased. Conversely, if the margin that must be satisfied for the NTN cell is higher when a UE reselects a cell from a TN cell to a NTN cell, the possibility of the UE to reselect to the NTN cell may be decreased. That is, by adjusting the margin, the UE may be served by the TN cell easily.

In NTN cell, cell reselection and rank setting process may be considered with less margin for TN cell. It may be applied differently depending on the scenario, such as NTN to NTN, TN to NTN or NTN to TN as follows. But, in case of NTN to NTN or TN to NTN, same margin may be applied because target cell is NTN cell.

### NTN to NTN

In the NTN environment, the near-far effect (a phenomenon in which the attenuation of the signal strength is observed as the distance from the center of the cell is observed) is not clearly observed. That is, the attenuation and increase of the signal strength is not clearly observed, so case that the signal strength of the target cell suddenly deteriorates or improves after a certain distance of the serving cell may occur. Therefore, margin that make reselection difficult may be considered.

### TN to NTN

As described above, in a situation where TN and NTN compete, since it is better to receive service from TN cell, margin that makes reselection to NTN difficult may be considered.

### NTN to TN

Similarly, since it is better to receive service from TN, margin that makes reselection to TN easy may be considered.

In the existing TN, the following ranks are considered. when rangeToBestCell is not configured, the cell is at least 3 dB dB better ranked in FR1 or 4.5 dB dB better ranked in FR2.

In the reselection/ranked process, there are several scenarios in addition to the above scenario examples, and different values may be applied depending on the scenario. The above examples are only for explaining the principles. That is, other scenarios may also be applied.

In the above example, in order to force or make reselection to the TN cell easy, a reduced value as much as a first value may be applied to 3 dB and 4.5 dB described in above existing TN.

If, in order to give priority to being served by the TN cell, a negative margin may be considered. That is, even if the signal of the TN cell is weaker than that of the NTN satellite, the UE may be forced to access the TN cell.

In this process, i) the distance between the TN base station/NTN satellite (or the reference location of the satellite) and the UE, ii) the cell service time of the surrounding NTN satellite including the serving cell (etc.) may be taken into consideration to determine the margin.

In the above example, in order to consider making reselection to the NTN cell difficult, an increased value as much as the second value may be applied to 3 dB and 4.5 dB. Also, in the case of NTN to NTN reselection, an increased value by the third value may be considered. a reduced value by the fourth value in an area with a clear boundary may be considered.

The first value, the second value, the third value and the fourth value may be the same or different. The first value, the second value, the third value and the fourth value may be changed in real time or a fixed value according to the NW configuration.

In the present specification, rather than suggesting setting a specific value, a principle/method of making reselection of a target cell easy/difficult is described, but a value similar to 3 dB may be used for the first value, the second value, the third value and the fourth value in general.

In addition, even if the TN cell and the NTN cell are in an equal priority state, reselection to the TN cell may be prioritized when the TN cell is searched.

The following criteria may be applied.
In the existing TN

The cell-ranking criterion Rₛ for serving cell and Rₙ for neighboring cell are defined by:

$${\text{R}}_{\text{s}} = {\text{Q}}_{\text{meas,s}} + {\text{Q}}_{\text{hyst}} \text{-} {\text{Qoffset}}_{\text{temp}}$$

$${\text{R}}_{\text{n}} {\text{=Q}}_{\text{meas,n}} \text{-} \text{Qoffset} \text{-} {\text{Qoffset}}_{\text{temp}}$$

Where: Qₘₑₐₛ is RSRP measurement quantity used in cell reselections.

For intra-frequency, Qoffset is equals to Qoffset_{s,n}, if Qoffset_{s,n} is valid, otherwise this equals to zero.

For inter-frequency, Qoffset is equals to Qoffset_{s,n} plus Qoffset_{frequency}, if Qoffset_{s,n} is valid, otherwise this equals to Qoffset_{frequency}.

Qoffsetₜₑₘₚ is offset temporarily applied to a cell.
Suggestion for NTN environment

The cell-ranking criterion Rₛ for serving cell and Rₙ for neighboring cell may be defined by:

$${\text{R}}_{\text{s}} \text{=} {\text{Q}}_{\text{meas,s}} \text{+} {\text{Q}}_{\text{hyst}} \text{-} {\text{Qoffset}}_{\text{temp}}$$

$${\text{R}}_{\text{n\_TN}} = {\text{Q}}_{\text{meas,n}} \text{-} \text{Qoffset\_TN} \text{-} {\text{Qoffset}}_{\text{temp}}$$

$${\text{R}}_{\text{n\_NTN}} = {\text{Q}}_{\text{means,n}} \text{-} \text{Qoffset\_NTN} \text{-} {\text{Qoffset}}_{\text{temp}}$$

By setting the offset value for the TN cell of the NTN UE and the offset value for the NTN cell differently, reselection to the TN cell can be performed easier even if the signal to the TN cell is weaker than the existing criteria.

In the above operation, by setting the priority for the E-UTRA inter RAT carrier higher than that of the NR NTN cell, the UE may preferentially search/measure the TN cell when the UE cannot find a suitable NR cell. The operation may proceed similarly to the above-described operation.

Also, when the UE in idle/inactive mode changes the mode to the connected mode (or just before the change) for QoS or data rate, the UE may perform preferential measurement/discovery of the TN cell.

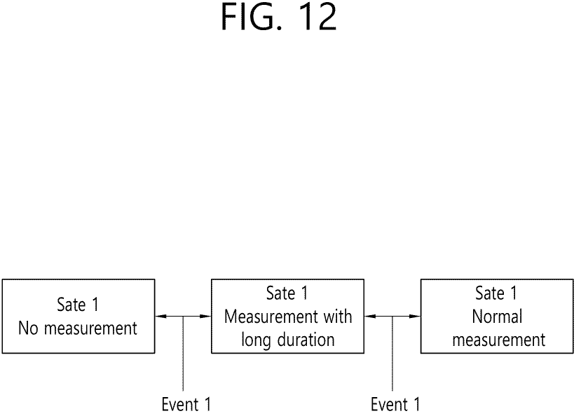

FIG. 12 shows shows a state of a UE related to measurement according to an embodiment of the present specification.

In the operation of the UE, since the service area of the satellite is very large, measurement relaxation may also be considered.

The UE may be in three states, and the measurement described in FIG. 12 may mean the measurement of the TN.

The UE in state 1 may not measure a signal of the TN base station at all. The UE may not measure a signal for any TN base station until event 1 is triggered.

The UE in state 2 may measure a signal of the TN base sation with a long period. This state is maintained until event 2 is triggered. If the inverse of the trigger condition of event 1 is established, state of the UE may become state 1.

The UE in state 3 may measure a signal of the TN base station with a general measurement period. If the inverse of the trigger condition of event 2 is established, state of the UE may become state 2.

The distance between the UE served by NTN satellite and reference location of the NTN satellite is D. According to D, state of the UE is as following.
If D is lower than threshold D1, the UE may recognize that it is about the center in the service area of the NTN satellite. The UE may not need signal measurement of TN cell. In this case, the UE may be in state 1.
If D satisfies D1<D<D2 with respect to a specific threshold D2 (D1<D2), the UE may be in the middle of the service area edge and center of the NTN satellite. The UE may need to measure other cells. The UE may be in state 2. In this case, The UE may preferentially search/measure the TN base station.
If D satisfies D>D3 with respect to a specific threshold D3 (D3>D2), the UE may be at the edge of the service area and may be in state 3. The UE in state 3 may measure neighboring cells with a certain period.

In the above examples according to D, since the service area of the NTN satellite is very large, only two of the above states can be applied. For example, only D1 and D3 may be applied, the state of the UE may be divided into two states which are only state 1 and state 3. Alternatively, only D2 and D3 may be applied, the state of the UE may be divided into two states which are only state 2 and state 3.

The method of the B may be described with a series of operation examples as follows. (a method of setting reselection margin in NTN-TN environment)

Step 1. The UE may evaluate the signal of the neighbor cell through the steps of discovery/measurement/evaluation.

Step 2-1. The UE served by NTN cell may perform reselection to neighbor cell (TN cell) if signal strength of the neighbor cell is higher than that of serving cell (NTN cell) by a threshold value, which is lower than 3 dB (e.g., 2 dB). (In the existing TN environment, in the case of FR1, the UE performs reselection to a neighboring cell 3 dB higher than that of the serving cell)

Step 2-2. In the opposite case, The UE served by TN may perform reselection to neighbor cell (NTN cell) if signal strength of the neighbor cell is higher than that of serving cell (NTN cell) by a threshold value, which is higher than 3 dB (e.g., 4 dB).

After the above procedure, serving cell for the UE may be changed the serving cell by reselection.

### 2. When the UE is in RRC Connected

The network may evaluate the location of the UE through the location or delay information reported from the UE. Alternatively, the location of the UE may be evaluated through PRS (etc.) of the UE. If the network determines that the location of the UE is sufficiently close to the TN base station, the network may allocate TN base station measurement information (frequency, etc.), Measurement Gap, SMTC (etc.) to the UE so that the UE can measure the TN base station preferentially.

In this case, a reference distance (at which the network determines that the location of the UE is sufficiently close to the TN base station) may be considered a normal base station coverage (5 km in the case of a 43 dBm Tx power rular macro base station) according to the base station power.

If the satellite signal is much weaker than signal from the base station at the edge of the base station coverage, the reference distance may be ‘N * the normal base station coverage’. The N may be a natural number such as 1, 2 or 3. In case of completely open land, N may be 120 as maximum value. N may be 3 or less than 3 usually.

The TN base station measurement information may be included in measurement information. Alternatively, when network transmit surrounding satellite information (orbit information and remaining service time) to the UE, the network may include the actual location of the TN base station in the orbit information included in the surrounding satellite information. Then UE may be able to measure TN base station. However, since service time to be configured may be infinite, the problem that the UE cannot distinguish between the GEO and TN may occur. In this case, the network may include the altitude information of the TN base station and speed and acceleration set to 0 in the orbit information so that the UE can identify the TN base station.

In addition, when multiple configurations for a TN cell and an NTN cell are configured in the UE, the priority of the TN cell in gap sharing factor may be configured high to allow the UE to measure the TN cell first.

### 3. Other

In case NTN to NTN, in an area where only satellite signals can be searched, which satellite cell has a high priority may vary based on the RRC state or location of the UE.
(1) When the UE is in RRC connected state
   The UE may report to the network that high data rate is required. Alternatively, the network determines by itself that the UE requires high data rate. When the network recognizes that the UE requires a high data rate, the network may configure priority for LEO (low Earth orbit) high to the UE.
   If the UE determines that high data rate is required by itself, the UE may search/measure LEO satellites with the highest priority based on the ephemeris information/remaining service time delivered from the network.
(2) When the UE is in RRC idle/inactive state

The UE may search/reselect GEO satellites with the highest priority based on the ephemeris information delivered from the network.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings.

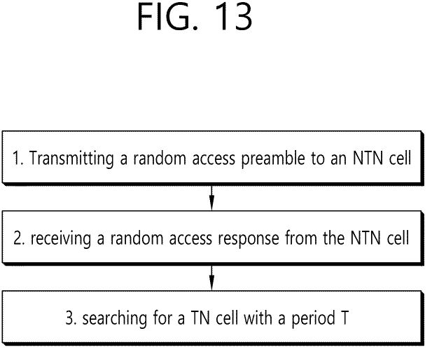

FIG. 13 shows a procedure of UE according to the first disclosure of the present specification.

1. The UE may transmit random access preamble to an NTN (Non-Terrestrial Network) cell.

2. The UE may receive random access response from the NTN cell.

3. The UE may search for a TN (Terrestrial Network) cell with a period T.

The T may be determined based on i) distance from the TN cell, ii) signal power from the TN cell and iii) service time of the NTN cell.

The step of searching for the TN cell may be performed, based on i) the distance between location of the UE and reference location of the TN cell being less than a threshold value D, ii) the NTN cell designating the TN cell to search or iii) service time of the NTN cell being less than a threshold value.

The threshold value D may be based on coverage of base station of the TN cell or signal strength of the NTN cell.

The UE may receive system information from the NTN cell.

The step of searching for the TN cell may be performed, based on the system information including information about discoverable TN cell.

The UE may measure signal strength of the TN cell, based on the UE searching for the TN cell.

The UE may determine reselection to the TN cell, based on signal strength of the TN cell being higher than signal strength of the NTN cell by a threshold value K or more.

The UE may perform reselection to the TN cell.

The threshold value K may be less than 3 dB in FR1 (frequency range 1) and less than 4.5 dB in FR2.

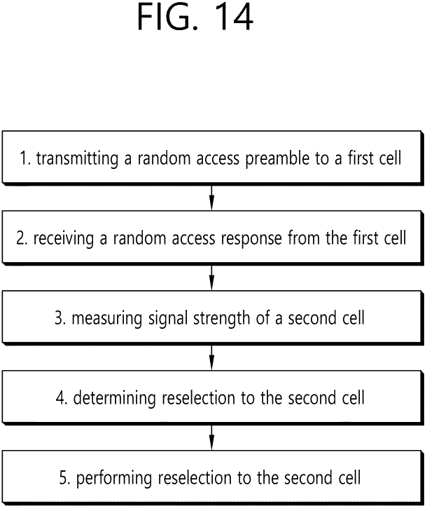

FIG. 14 shows a procedure of UE according to the second disclosure of the present specification.

1. The UE may transmit random access preamble to a first cell.

2. The UE may receive random access response from the first cell.

3. The UE may measure signal strength of a second cell.

4. The UE may determine reselection to the second cell, based on signal strength of the second cell being higher than signal strength of the NTN cell by a threshold value K or more.

The threshold value K may be less than 3 dB in FR1 (frequency range 1) and less than 4.5 dB in FR2, based on the first cell being an NTN (Non-Terrestrial Network) cell and the second cell being a TN (Terrestrial Network) cell.

The threshold value K may be higher than 3 dB in FR1 and higher than 4.5 dB in FR2, based on the first cell being a TN cell and the second cell being an NTN cell;

5. The UE may perform reselection to the second cell.

The threshold value K may be higher than 3 dB in FR1 and higher than 4.5 dB in FR2, based on the first cell being an NTN cell and the second cell being an NTN cell.

Hereinafter, a device configured to operate in a wireless system, according to some embodiments of the present disclosure, will be described.

For example, a terminal may include a processor, a transceiver, and a memory.

For example, the processor may be configured to be coupled operably with the memory and the processor.

The processor may be configured to: transmitting a random access preamble to an NTN (Non-Terrestrial Network) cell; receiving a random access response from the NTN cell; searching for a TN (Terrestrial Network) cell with a period T, wherein the T is determined based on i) distance between location of the UE and reference location of the TN, ii) signal power from the TN cell and iii) service time of the NTN cell.

Hereinafter, an apparatus in a mobile communication, according to some embodiments of the present disclosure, will be described.

The processor may be configured to: transmitting a random access preamble to an NTN (Non-Terrestrial Network) cell; receiving a random access response from the NTN cell; searching for a TN (Terrestrial Network) cell with a period T, wherein the T is determined based on i) distance between location of the UE and reference location of the TN, ii) signal power from the TN cell and iii) service time of the NTN cell.

Hereinafter, a non-transitory computer-readable medium has stored thereon a plurality of instructions in a wireless communication system, according to some embodiments of the present disclosure, will be described.

According to some embodiment of the present disclosure, the technical features of the present disclosure could be embodied directly in hardware, in a software executed by a processor, or in a combination of the two. For example, a method performed by a wireless device in a wireless communication may be implemented in hardware, software, firmware, or any combination thereof. For example, a software may reside in RAM memory, flash memory, ROM memory, EPROM memory, EEPROM memory, registers, hard disk, a removable disk, a CD-ROM, or any other storage medium.

Some example of storage medium is coupled to the processor such that the processor can read information from the storage medium. In the alternative, the storage medium may be integral to the processor. The processor and the storage medium may reside in an ASIC. For other example, the processor and the storage medium may reside as discrete components.

The computer-readable medium may include a tangible and non-transitory computer-readable storage medium.

For example, non-transitory computer-readable media may include random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, or any other medium that can be used to store instructions or data structures. Non-transitory computer-readable media may also include combinations of the above.

In addition, the method described herein may be realized at least in part by a computer-readable communication medium that carries or communicates code in the form of instructions or data structures and that can be accessed, read, and/or executed by a computer.

According to some embodiment of the present disclosure, a non-transitory computer-readable medium has stored thereon a plurality of instructions. The stored a plurality of instructions may be executed by a processor of UE.

The stored a plurality of instructions may cause the UE to transmit a random access preamble to an NTN (Non-Terrestrial Network) cell; receive a random access response from the NTN cell; search for a TN (Terrestrial Network) cell with a period T, wherein the T is determined based on i) distance between location of the UE and reference location of the TN, ii) signal power from the TN cell and iii) service time of the NTN cell.

The present disclosure can have various advantageous effects.

For example, by adjusting the measurement period, the battery consumption of the terminal can be reduced, cell search can be performed effectively, and efficient mobility support can be expected.

For example, by making it easier for a UE to be served in the TN cell, better communication quality can be provided to the user.

Advantageous effects obtained through specific examples of the present specification are not limited to the effects listed above. For example, there may be a variety of technical effects that a person having ordinary skill in the related art can understand or derive from this specification. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

What is claimed is:

1. A method for radio communication, performed by a user equipment (UE), comprising:
transmitting a random access preamble to an NTN (Non-Terrestrial Network) cell;
receiving a random access response from the NTN cell;
searching for a TN (Terrestrial Network) cell with a period T,
wherein the T is determined based on i) distance between location of the UE and reference location of the TN, ii) signal power from the TN cell and iii) service time of the NTN cell.

2. The method of claim 1,
wherein the step of searching for the TN cell is performed, based on i) the distance between location of the UE and reference location of the TN cell being less than a threshold value D, ii) the NTN cell designating the TN cell to search or iii) service time of the NTN cell being less than a threshold value.

3. The method of claim 2,
wherein the threshold value D is based on coverage of base station of the TN cell or signal strength of the NTN cell.

4. The method of claim 1, further comprising:
receiving system information from the NTN cell;
wherein the step of searching for the TN cell is performed, based on the system
information including information about discoverable TN cell.

5. The method of claim 1, further comprising:
measuring signal strength of the TN cell, based on the UE searching for the TN cell;
determining cell reselection to the TN cell, based on signal strength of the TN cell being stronger than signal strength of the NTN cell by a threshold value K or more;
performing cell reselection to the TN cell.

6. The method of claim 5,
wherein the threshold value K is less than 3 dB in FR1 (frequency range 1) and less than 4.5 dB in FR2.

7. A method for radio communication, performed by a user equipment (UE), comprising:
transmitting a random access preamble to a first cell;
receiving a random access response from the first cell;
measuring signal strength of a second cell;
determining cell reselection to the second cell, based on signal strength of the second cell being higher than signal strength of the NTN cell by a threshold value K or more,
wherein the threshold value K is less than 3 dB in FR1 (frequency range 1) and less than 4.5 dB in FR2, based on the first cell being an NTN (Non-Terrestrial Network) cell and the second cell being a TN (Terrestrial Network) cell,
wherein the threshold value K is higher than 3 dB in FR1 and higher than 4.5 dB in FR2, based on the first cell being a TN cell and the second cell being an NTN cell;
performing cell reselection to the second cell.

8. The method of claim 7,
wherein the threshold value K is higher than 3 dB in FR1 and higher than 4.5 dB in FR2, based on the first cell being an NTN cell and the second cell being an NTN cell.

9. A device configured to operate in a wireless system, the device comprising:
a transceiver,
a processor operably connectable to the transceiver,
wherein the processor is configured to:
transmitting a random access preamble to an NTN (Non-Terrestrial Network) cell;
receiving a random access response from the NTN cell;
searching for a TN (Terrestrial Network) cell with a period T,
wherein the T is determined based on i) distance between location of the UE and reference location of the TN, ii) signal power from the TN cell and iii) service time of the NTN cell.
